(19) United States
(12) Patent Application Publication
(10) Pub. No.: US 2009/0252199 A1
(43) Pub. Date: Oct. 8, 2009

(54) TEMPERATURE MEASUREMENT DEVICE

(75) Inventor: TAY-JIAN LIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/411,347

(22) Filed: Mar. 25, 2009

(30) Foreign Application Priority Data
Apr. 3, 2008 (CN) 200810066395.X

(51) Int. Cl. G01K 1/00

(52) U.S. Cl. 374/208; 374/E01.001

(57) ABSTRACT

A temperature measurement device includes a first member forming a first claw at an end thereof and a second member forming a second claw at an end thereof. The second claw faces the first claw, and can move towards and away from the first claw. A spring is provided between the first member and the second member for generating force to move the second claw towards the first claw. A pair of thermal coupling wires is fixed on one of the first and second claws facing the other of the first and second claws. Thus an object needed to be measured can be arranged between the first and second claws and snugly engage the thermal coupling wires by the elastic force of the deformed spring.

### CROSS-REFERENCE TO RELATED APPLICATION

This application is related to a co-pending application entitled “TEMPERATURE MEASUREMENT DEVICE HAVING SEPARABLE THERMAL COUPLING WIRES”, filed ______ (Atty. Docket No. US20387), and assigned to the same assignee of this application. The disclosure of the co-pending application is wholly incorporated herein by reference.

### BACKGROUND

1. Technical Field

The disclosure generally relates to temperature measurement devices, and more particularly to a temperature measurement device which can lower an interface thermal resistance between the temperature measurement device and an object to be measured.

2. Description of Related Art

Thermocouples are widely used as temperature measurement devices for measuring the temperature of an object. The thermocouple includes two different metals, and produces a small unique voltage for a given temperature. The voltage generated by the thermocouple is measured and interpreted by a thermocouple thermometer. During operation, the different metals of the thermocouple attach to the object to be measured, and soon a heat balance is reached between the different metals and the object, and the different metals produce a voltage corresponding to detected temperature. However, the contact surfaces between the different metals of the thermocouple and the object can be rough and loose, such that the interface thermal resistance between the thermocouple and the object is relatively high, resulting in a response speed of the temperature measurement of the object to be slow. Even after time, the temperature of the different metals of the thermocouple may not reach the same temperature as the object. Temperature measured by the thermocouple is not accurate.

For the foregoing reasons, there is a need in the art for a temperature measurement device which can overcome the limitations described.

### BRIEF DESCRIPTION OF THE DRAWINGS

FIG. 1 is a side view of a temperature measurement device according to a first embodiment.

FIG. 2 is an isometric view of a detection member of the temperature measurement device of FIG. 1.

FIG. 3 is an isometric view of thermal coupling wires of the detection member of FIG. 2.

FIG. 4 is an isometric view of a detection member of a temperature measurement device according to a second embodiment.

FIG. 5 is an isometric view of the thermal coupling wires of the detection member of FIG. 4.

FIG. 6 is a cross section of a temperature measurement device according to a third embodiment.

FIG. 7 is a cross section of a temperature measurement device according to a fourth embodiment.

FIG. 8 is a cross section of a temperature measurement device according to a fifth embodiment.

FIG. 9 is an isometric view of the detection member of the temperature measurement device of FIG. 8.

### DETAILED DESCRIPTION

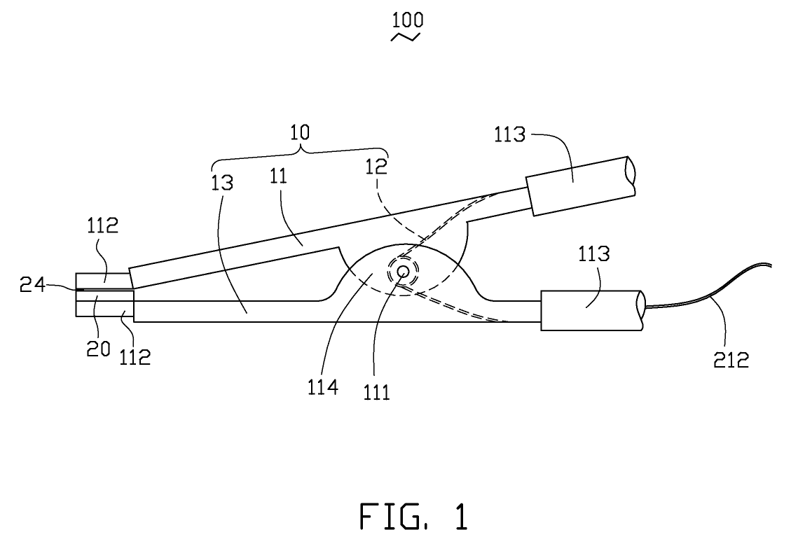

Referring to FIG. 1, a temperature measurement device 100 for an object according to a first embodiment includes a clamping member 10 and a detection member 20.

The clamping member 10 includes a first grip 11, a second grip 13, and a spring 12 provided between the first grip 11 and the second grip 13. The first grip 11 and the second grip 13 are substantially identical, and face each other. In this embodiment, the first grip 11 is arranged over the second grip 13. Each of the first grip 11 and the second grip 13 includes a claw 112 and a handle 113 formed at two opposite ends (i.e., first and second ends) thereof, respectively. Each claw 112 forms a planar inner side 24 facing the other claw 112. A pivotal section 114 extends from a middle of each of the first and second grips 11, 13 towards the other grip 13, 11. A pin 111 is pivotally connected between the pivotal sections 114 of the two grips 11, 13 to assemble the first grip 11 and the second grip 13 together.

The spring 12 is a torque spring providing clamping member 10 with elastic clamping force. The spring 12 surrounds the pin 111 with two ends thereof abutting inner sides of the handles 113 of the first grip 11 and the second grip 13, respectively. Thus the handles 113 are spaced from each other, and the claws 112 are close to each other under the action of the elastic force of the spring 12. When pressure is exerted on the handles 113 of the first grip 11 and the second grip 13, the spring 12 is compressed. Thus the handles 113 are caused to close to each other, and the claws 112 of the first grip 11 and the second grip 13 are separated to accommodate a target object to be measured therebetween.

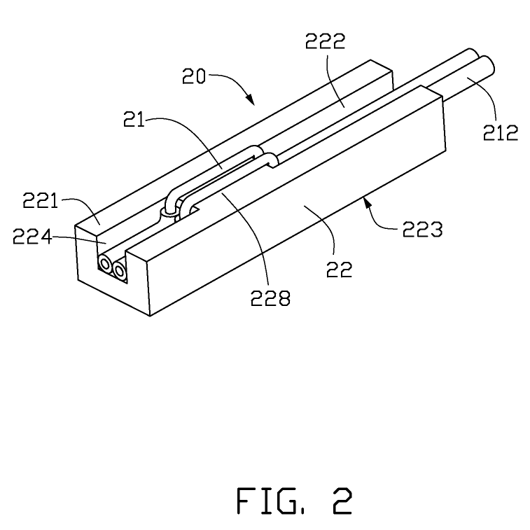

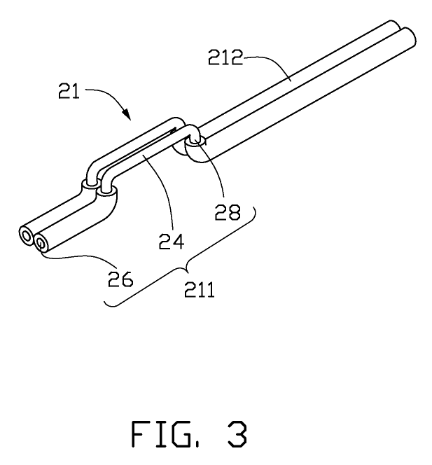

The detection member 20 is fixed on the inner side 24 of the claw 112 of the second grip 13 of the clamping member 10. Alternatively, the detection member 20 can be fixed on the inner side 24 of the claw 112 of the first grip 11. Referring to FIGS. 2 and 3, the detection member 20 includes a supporting element 22 and a pair of thermal coupling wires 21 fixed on the supporting element 22.

The supporting element 22 is material providing thermal and electrical insulation. The supporting element 22 is rectangular, and includes a flat top surface 221 and a flat bottom surface 223 parallel to the top surface 221. The bottom surface 223 of the supporting element 22 is fixed to the inner side 24 of the claw 112 of the second grip 13. A first groove 224 is concaved from a first side of the top surface 221 of the supporting element 22, and a second groove 222 is concaved from a second side of the top surface 221 of the supporting element 22. The first groove 224 and the second groove 222 are shallower than a thickness of the supporting element 22. The first and second grooves 224, 222 are spaced from each other, with a bridge 228 formed therebetween by the top surface 221 of the supporting element 22. As viewed from a top side, the top surface 221 of the supporting element 22 is substantially H-shaped.

The two thermal coupling wires 21 on the supporting element 21 are substantially parallel to and spaced from each other. Each of the thermal coupling wires 21 constitutes an insulating layer 212 covering a bare wire 211. The bare wires 211 of the two thermal coupling wires 21 are of dissimilar metals. Each bare wire 211 includes a middle portion 24, a first end portion 26 bending from a first end of the middle portion 26, and a second end portion 28 bending from a second end of the middle portion 24. The insulating layer 212 only surrounds the first and second end portions 26, 28 of the bare wire 211, and the middle portion 24 of the bare wire 211 is exposed to form a contact portion of the thermal coupling wire 21. The contact portion of each thermal coupling wire 21 has a length substantially equal to that of the bridge 228 of the supporting element 22, and is located on the bridge 228. The first end portions 26 of the thermal coupling wires 21 are received in the first groove 224, and the second end portions 28 of the thermal coupling wires 21 are received in the second groove 222.

During operation of the temperature measurement device 100, the second end portions 28 of the thermal coupling wires 21 extend along the handle 113 of the second grip 13 of the clamping member 10 to electrically connect to a thermocouple thermometer (not shown). Pressure is exerted on the handles 113 to separate the claws 112. The target object can thus be gripped between the claws 112 by the elastic force of the spring 12 separating the handles 113 of the clamping member 10 with the claws 112 of the first grip 11 and the second grip 13 of the clamping member 10 opposingly impelled toward each other. The object thus snugly meets the contact portions of the thermal coupling wires 21 of the detection member 20 arranged on the claw 112 of the second grip 13. Accordingly, heat resistance between the object and thermal coupling wires 21 is significantly decreased, and the thermal coupling wires 21 are more effectively responsive to temperature. Measurement of temperature by the temperature measurement device 100 is thus more accurate.

After measurement is accomplished, pressure is exerted on the handles 113 of the clamping member 10 to separate the claws 112, allowing easy removal of or departure of the temperature measurement device 100 from the object. The time for measurement of a single object is shortened, and the precision of the temperature measurement device 100 is improved.

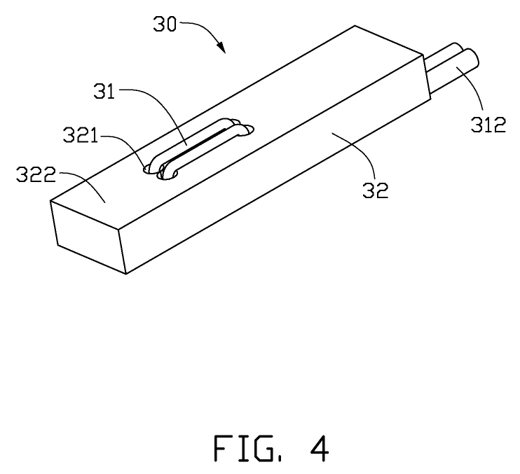

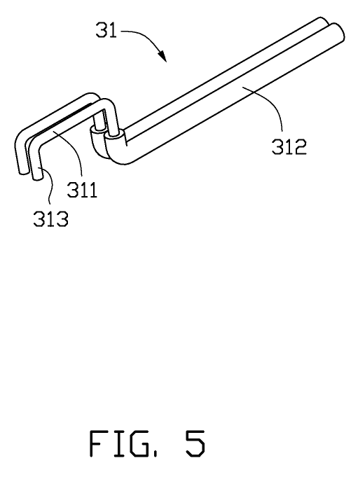

FIGS. 4 and 5 show a second embodiment of the detection member 30 of the temperature measurement device. The detection member 30 includes a supporting element 32 and a pair of thermal coupling wires 31. The supporting element 32 is rectangular, and defines four through holes 321 therein. The four through holes 321 are arranged in two rows by two lines. The thermal coupling wires 31 each have a middle portion 311 of a bare wire, a left bending portion 313, and a right bending portion 312 constituted by a bare wire covered partially by an insulating layer. The middle portions 311 form the contact portions of the thermal coupling wires 31, and are located on a top surface 322 of the supporting element 32. The left bending portions 313 are inserted into two through holes 321, and the right bending portions 312 are inserted into the other through holes 321 and then extend through the supporting element 32, connecting to the thermocouple thermometer. Similar to the first embodiment, the detection member 30 can be fixed on the inner side 24 of the claw 112 with the contact portions of the thermal coupling wires 31 exposed for contacting the object to be measured.

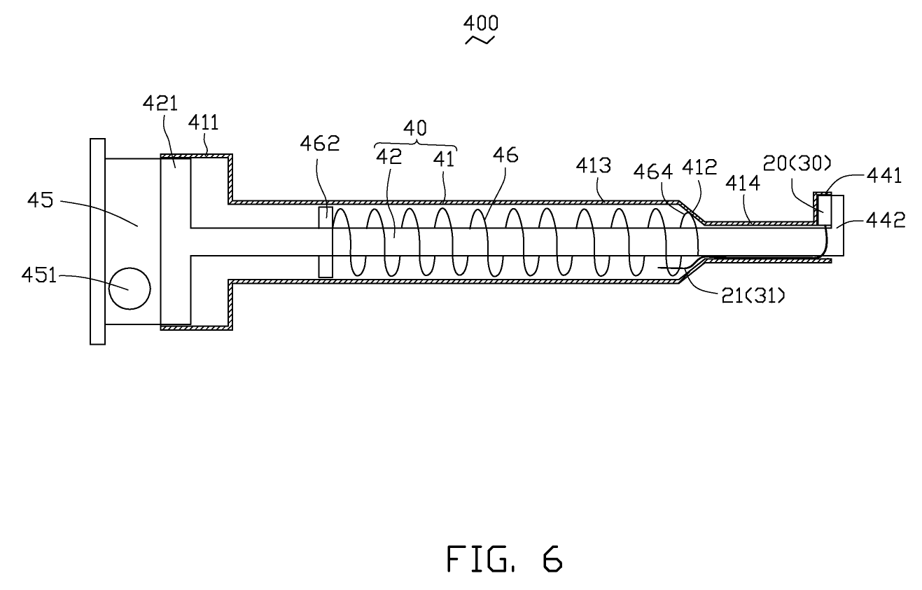

FIG. 6 shows a temperature measurement device 400 according to a third embodiment, differing from the previous embodiments only in that the clamping member 40 includes a hollow tube 41 and a solid shaft 42 received therein. The tube 41 includes a middle portion 413, a first end portion 411 having an inner diameter larger than that of the middle portion 413, and a second end portion 414 having an inner diameter smaller than that of the middle portion 413. A first claw 441 extends upwardly from a distal end of the second end portion 414 of the tube 41. The first claw 441 is perpendicular to an axis of the tube 41, and can be integrally formed with the tube 41 by bending the distal end of the second end portion 414 of the tube 41.

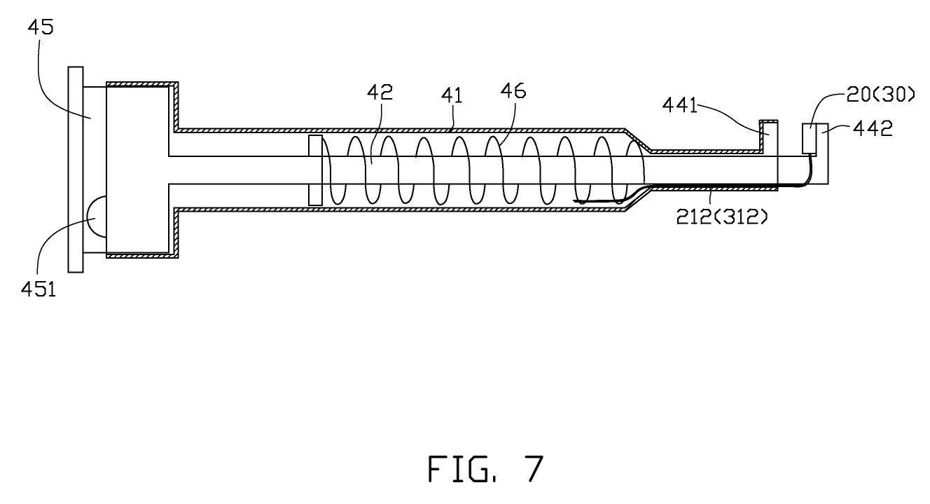

A diameter of the shaft 42 can be substantially the same or smaller than the inner diameter of the second end portion 414 of the tube 41. In this embodiment, the diameter of the shaft 42 is substantially the same as the inner diameter of the second end portion 414, and a length of the shaft 42 is substantially the same as that of the tube 41. A second claw 442 extends upwardly from an end of the shaft 42 corresponding to the first claw 441 of the tube 41. The first claw 441 and the second claw 442 are parallel, with the second claw 442 located at a lateral side of and linearly moveable relative to the first claw 441. The detection member 20 (30) is fixed on the first claw 441 with the contact portions facing the second claw 442. Alternatively, as shown in FIG. 7, the detection member 20 (30) can be fixed on the second claw 442 with the contact portions facing the first claw 441.

A coil spring 46 is received in the middle portion 413 of the tube 41 and surrounds the shaft 42. A diameter of the coil spring 46 exceeds the inner diameter of the second end portion 414, and not larger than the inner diameter of the middle portion 413 of the tube 41. A first end 462 of the coil spring 46 is fixed onto the shaft 42. When the temperature measurement device is not in use, i.e., the claws 441, 442 are closed to each other without the object, the coil spring 46 is free with a second end 464 thereof abutting a joint part 412 of the middle portion 413 and the second end portion 414 of the tube 41. A flat plate 421 is formed at a first end of the shaft 42 with a diameter substantially equal to the inner diameter of the first end portion 411 of the tube 41. The flat plate 421 is slidably received in the first end portion 411. The flat plate 421 is perpendicular to the shaft 42. A handling portion 45 extends outwardly from the flat plate 421 of the shaft 42. An opening 451 is defined in the handling portion 45 for extension of the thermal coupling wires 21 (31) of the detection member 20 (30) of the temperature measurement device 400 therethrough to connect to the thermocouple thermometer.

During operation, the handling portion 45 is pressed to move outward, and thus the shaft 42 moves correspondingly to compress the coil spring 46. The second claw 442 of the shaft 42 moves away from the first claw 441 for the outward movement of the shaft 42. Thus the object can be gripped between the first and the second claws 441, 442. Pressure on the handling portion 45 of the shaft 42 is moved, such that the first claw 441 and the second claw 442 with the detection member 20 can tightly engage the object for measurement by the action of the compressed coil spring 46.

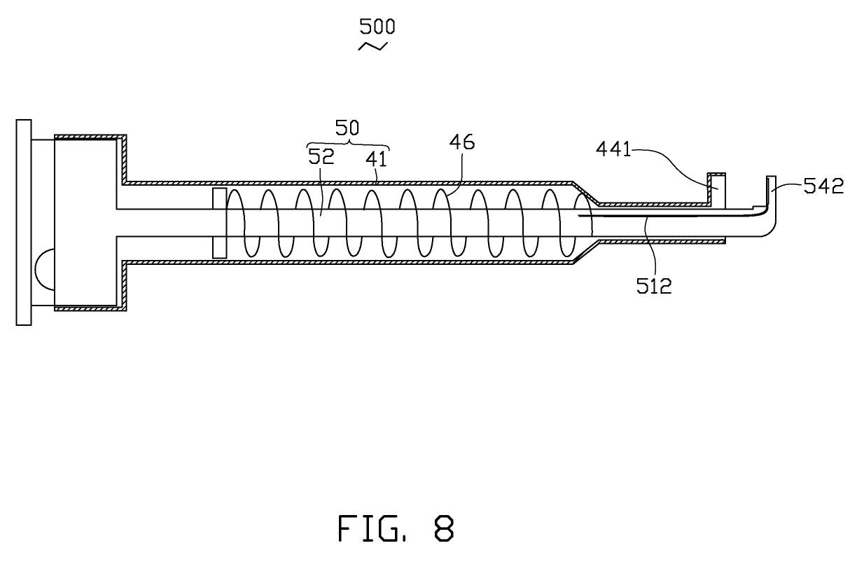

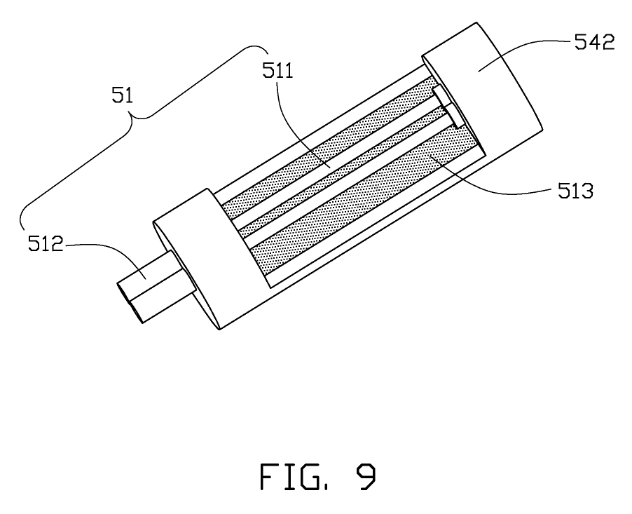

FIGS. 8 and 9 show a fifth embodiment of a temperature measurement device 500 differing from the temperature measurement device 400 of the previous embodiment only in the absence of the supporting element 22 (32) of the detection member 20 (30) and a modified shaft 52. The clamping member 50 includes a tube 41 and the shaft 52 extending therethrough. The tube 41 is substantially the same as the third embodiment, and forms a first claw 441 at a first end thereof. The shaft 52 of the clamping member 50 is hollow. A first end of the hollow shaft 52 is bent upwardly with a side thereof adjacent to the first claw 441 being cut. The first end of the hollow shaft 52 forms the second claw 542. Similarly, the spring 46 is fixed on the shaft 52. When the shaft 52 is moved outward, the second claw 542 separates from the first claw 441 to accommodate an object therebetween. The contact portions 511 of the thermal coupling wires 51 are fixed to the cut side of the second claw 542 directly, and the end portions 512 of the thermal coupling wires 52 with the insulating layer extend through the hollow shaft 52 to connect to the thermocouple thermometer. An insulating layer 513 is coated on the cut side of the second claw 542 insulating the contact portions 511 of the thermal coupling wires 51 from the second claw 542. Thus the supporting element 22 (32) of the detection member 20 (30) is avoided, reducing cost and size of the temperature measurement device 500.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A temperature measurement device for measuring the temperature of an object, comprising:
a clamping member having a pair of claws and a spring, the spring providing force to close the pair of claws and thereby enabling the claws to clamp the object therebetween; and
a pair of thermal coupling wires fixed on one of the claws for snugly engaging the object during measurement by action of the spring.

2. The temperature measurement device of claim 1, wherein the clamping member comprises a pair of grips facing each other, and a pin interconnecting middle portions of the pair of grips, the spring surrounding the pin and having two ends abutting inner sides of first ends of the pair of grips, respectively, the other ends of the pair of grips forming the pair of claws.

3. The temperature measurement device of claim 2, wherein both of the thermal coupling wires are fixed on a supporting element of a material providing thermal and electrical insulation, and the supporting element is fixed on one of the claws.

4. The temperature measurement device of claim 3, wherein each thermal coupling wire comprises a bare wire with ends thereof embedded into an insulating layer, and a portion of the thermal coupling wire without the insulating layer is fixed on an outer surface of the supporting element, and ends of the thermal coupling wire with the insulating layer are received in the supporting element.

5. The temperature measurement device of claim 4, wherein a pair of spaced grooves are depressed from the outer surface of the supporting element, and a bridge is formed between the grooves by the outer surface of the supporting element, the portion of each thermal coupling wire without the insulating layer being disposed on the bridge, and the ends of the thermal coupling wire with the insulating layer being received in the grooves.

6. The temperature measurement device of claim 4, wherein four spaced through holes are defined in the supporting element, the portion of the thermal coupling wire without the insulating layer bring located between the through holes, and the ends of the thermal coupling wire with the insulating layer being inserted into the four through holes, respectively.

7. The temperature measurement device of claim 1, wherein the clamping member comprises a hollow tube and a shaft moveably received in the tube, the pair of claws being formed on distal ends of the tube and the shaft respectively and perpendicularly to an axis of the tube, the spring having a first end fixed on the shaft away from the distal end of the tube and a second end abutting the tube near the distal end thereof, the spring being compressed and the claw of the shaft moving away from the claw of the tube when the shaft moves towards the distal end thereof along the axis.

8. The temperature measurement device of claim 7, wherein the thermal coupling wires are fixed on a thermal and electrical-insulating supporting element fixed on the claw of the tube.

9. The temperature measurement device of claim 7, wherein the thermal coupling wires are fixed on a thermal and electrical-insulating supporting element fixed on the claw of the shaft.

10. The temperature measurement device of claim 7, wherein the shaft is hollow, and the distal end of the shaft bends perpendicular with a part near the claw of the tube being cut to form the claw of the shaft, the thermal coupling wires being fixed on the claw of the shaft directly.

11. The temperature measurement device of claim 7, wherein the tube includes a middle portion, a first end portion having an inner diameter lager than that of the middle portion, and a second end portion having an inner diameter smaller than that of middle portion, the second end of the spring abutting a joint part of the second end portion and the middle portion of the tube, and the claw of the tube being formed at a distal end of the second end portion.

12. The temperature measurement device of claim 1, wherein the pair of thermal coupling wires are parallel and spaced from each other.

13. A temperature measurement device, comprising:
a first member forming a first claw at an end thereof;
a second member forming a second claw at an end thereof facing the first claw, the second claw moveable toward and away from the first claw;
a spring provided between the first member and the second member and generating force to move the second claw toward the first claw;
a pair of thermal coupling wires fixedly on one of the first and second claws facing the other of the first and second claws.

14. The temperature measurement device of claim 13, wherein the first member is a hollow tube, and the second member is a shaft received in the tube, the first and second claws are perpendicular to an axis of the tube, and the shaft moves along the axis of the tube to move the second claw towards and away from the first claw.

15. The temperature measurement device of claim 13, wherein the first member and the second member are two grips facing each other with middle portions thereof connected by a pin, the spring surrounding the shaft with two ends thereof abutting inner sides of other ends of the grips, respectively.
